(19) United States
(12) Patent Application Publication
(10) Pub. No.: US 2005/0074143 A1
(43) Pub. Date: Apr. 7, 2005

(54) Vehicle backing assist apparatus and vehicle backing assist method

(75) Inventor: Akio Kawai, Yamato-shi (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 10/952,867

(22) Filed: Sep. 30, 2004

(30) Foreign Application Priority Data
Oct. 2, 2003 (JP) 2003-344708

(51) Int. Cl. G06K 9/00; G01S 1/00

(52) U.S. Cl. 382/104; 701/300

(57) ABSTRACT

An image of a coupler at a connection target vehicle or an image of an identification marker provided near the coupler captured in advance with a camera, is stored in memory as a template image. A decision is made as to whether or not an image of the view behind a subject vehicle captured with the camera includes a portion matching the template image. If a portion matching the template image is judged to be included in the image of the view behind the subject vehicle, a guide line extending rearward from the coupler at the subject vehicle is drawn and displayed over the image of the view behind the subject vehicle.

### BACKGROUND OF THE INVENTION

1. Field of the Invention

The present invention relates to an apparatus and a method to be adopted to assist an operator during a vehicle backing operation.

2. Description of the Related Art

There is a vehicle backing assist apparatus known in the related art that displays a guide line with a distance marker drawn over an image of the view behind the vehicle in correspondence to the distance to a coupler at a trailer or the like when connecting a coupler on the vehicle side to the coupler of the trailer (see Japanese Laid Open Patent Publication No. 2002-359839). This apparatus generates the guide line by capturing an image of the view behind the vehicle, measuring the distance to the trailer and extending the vehicle centerline on the image, which runs along the widthwise center of the vehicle, rearward relative to the vehicle.

### SUMMARY OF THE INVENTION

The vehicle backing assist apparatus in the related art described above invariably draws the guide line over the image of the view behind the vehicle regardless of whether or not a coupler of a trailer or the like is present, as long as an obstacle has been detected behind the vehicle. As a result, even when a connection target vehicle such as a trailer to be connected with the subject vehicle is not present behind the subject vehicle and thus it is not necessary to display a guide line to assist a vehicle coupling operation, the guide line is superimposed over the display of the image of the view behind the vehicle. Under such circumstances, the operator may find the display of the unnecessary guide line distracting.

The vehicle backing assist apparatus according to the present invention makes a decision as to whether or not a connection target vehicle is present behind the subject vehicle and superimposes a guide line over the display of an image of the view behind the subject vehicle only if a connection target vehicle is judged to be present.

A vehicle backing assist apparatus according to the present invention includes an image capturing device that captures an image of a view behind a subject vehicle, a judging device that judges as to whether or not a connection target vehicle to be connected with the subject vehicle is present behind the subject vehicle based upon the captured image, a drawing device that draws a guide line extending rearward from a coupler at the subject vehicle over the image of the view behind the subject vehicle captured by the image capturing device when the judging device judges that the connection target vehicle to be connected with the subject vehicle is present, and a display device that displays an image of the view behind the subject vehicle with the guide line superimposed thereupon.

In a vehicle backing assist method according to the present, an image of a view behind a subject vehicle is captured and it is judged as to whether or not a connection target vehicle to be connected with the subject vehicle is present behind the subject vehicle based upon the captured image. Then, a guide line extending rearward from a coupler at the subject vehicle is drawn over the image of the view behind the subject vehicle if the connection target vehicle to be connected with the subject vehicle is determined to be present, and the image of the view behind the subject vehicle with the guide line superimposed thereupon is displayed.

### BRIEF DESCRIPTION OF THE DRAWINGS

FIG. 1 shows a vehicle having installed therein the vehicle backing assist apparatus in an embodiment and a connection target vehicle;

FIG. 2 shows the structure adopted in the vehicle backing assist apparatus in the embodiment;

FIG. 3 presents a flowchart of the trailer registration interrupt routine;

FIG. 4 is a front view of the trailer coupler side;

FIG. 5A presents an example of a hitch pattern template, FIG. 5B shows an example of a hitch pattern template assuming a different shape and FIG. 5C shows an identification marker having printed thereon an inherent pattern;

FIG. 6 is a front view of the coupler side of a trailer having an identification mark;

FIG. 7 presents a flowchart of the vehicle backing assist operation executed in conformance to a vehicle backing assist control program in the embodiment;

FIG. 8A shows the positional relationship between the subject vehicle and a trailer located over a distance of 7 m and FIG. 8B shows a corresponding image captured by the camera;

FIG. 9A shows the positional relationship between the subject vehicle and a trailer located over a distance of 5 m and FIG. 9B shows a corresponding image captured by the camera;

FIG. 10A shows the positional relationship between the subject vehicle and a trailer located over a distance of 3 m and FIG. 10B shows a corresponding image captured by the camera;

FIG. 11 shows the positional relationship between the subject vehicle and a trailer that is not positioned directly behind the subject vehicle;

FIG. 12 presents an example of a superimposed display of a trailer connection guideline, a steering instruction line and an estimated traveling course line over a camera image; and

FIG. 13 shows a camera image in which the steering instruction line and the estimated traveling course line in FIG. 12 are aligned with each other.

### DETAILED DESCRIPTION OF THE PREFERRED EMBODIMENT

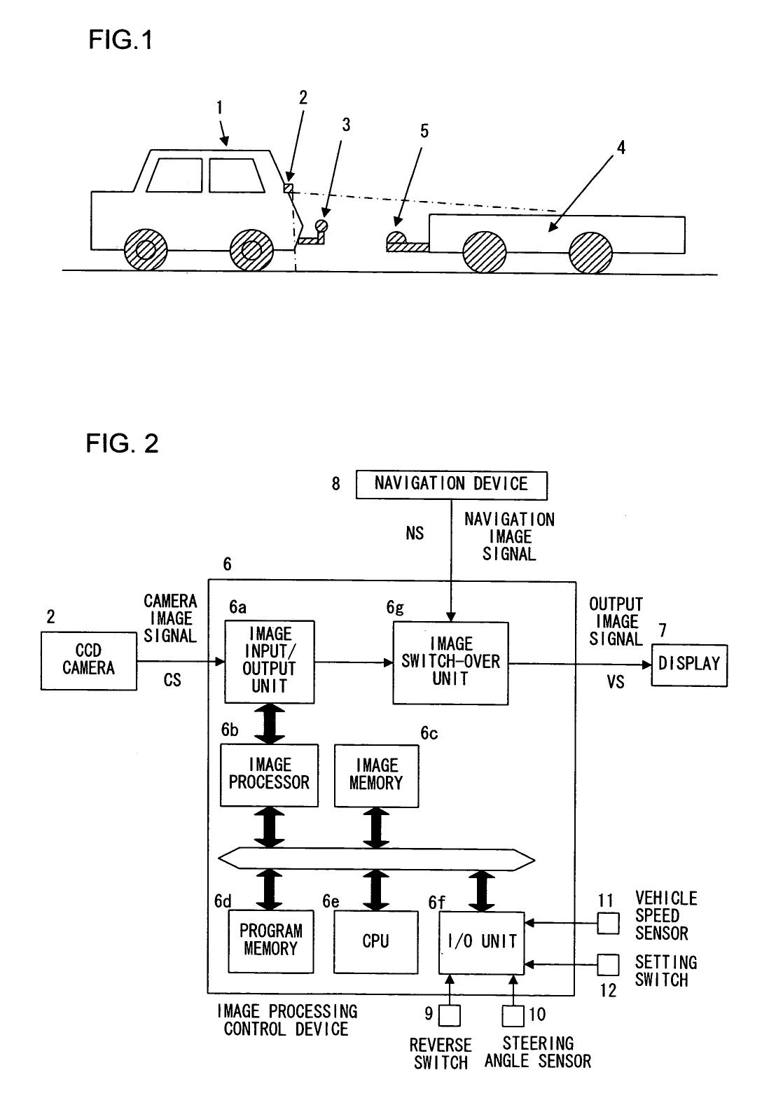

FIG. 1 shows a vehicle having the vehicle backing assist apparatus in an embodiment installed therein and a connection target vehicle. A CCD camera 2 installed at the rear of the vehicle 1 captures an image of the view behind the vehicle. This CCD camera 2 includes a wide angle (horizontal 120° or greater) photographic lens in order to monitor a wide range of area behind the vehicle. It is to be noted that instead of a CCD camera, the camera 2 may be a CMOS camera.

A coupler (hereafter referred to as a vehicle hitch) 3 is mounted at the center of the rear of the vehicle 1. This vehicle hitch 3 is connected with a hitch (hereafter referred to as a trailer hitch) 5 of a trailer (for example, travel trailer) 4.

FIG. 2 shows the structure adopted in the vehicle backing assist apparatus in the embodiment. An image CS of the view behind the vehicle captured by the CCD camera 2 mentioned above is input to an image processing control device 6. The image processing control device 6 executes various types of image processing on the camera image CS and also outputs an image VS by effecting a switch-over between the camera image CS and a navigation image which is to be detailed later. At a display 7, which may be installed at an instrument panel or the like of the vehicle, the image VS output from the image processing control device 6 is displayed. A navigation device 8, a reverse switch 9, a steering angle sensor 10, a vehicle speed sensor 11, a setting switch 12 and the like are connected to the image processing control device 6.

The navigation device 8 includes a GPS receiver that detects the current position of the vehicle and a storage device in which road maps are stored, and outputs a navigation image NS that indicates the vehicle current position on a road map. The reverse switch 9 detects a shift of the transmission (not shown) to the reverse gear position. The steering angle sensor 10 detects the steering angle of the steering system. The vehicle speed sensor 11 generates a pulse signal every time the vehicle has traveled a predetermined distance, detects the vehicle speed based upon the intervals with which the pulse signal is generated and detects the distance traveled by the vehicle by counting the signal pulses. The setting switch 12 is operated to register a trailer hitch pattern template, to select a registration area and the like.

Next, the internal structure of the image processing device 6 is explained. The image processing device 6 includes an image input/output unit 6a, an image processor 6b, an image memory 6c, a program memory 6d, a CPU 6e, an I/O unit 6f, an image switch-over unit 6g and the like. The image input/output unit 6a executes processing for converting the analog camera image CS to a digital image CS through decoding and for encoding the processed digital image CS to be reconverted to the original analog image CS. The image processor 6b is a dedicated image processor that executes various types of high-speed image processing such as arithmetic operations, logic operations, binary conversion operations, filter processing and geometric conversion on the digital camera image CS at the pixel level.

The image memory 6c, in which a plurality of sets of image data are stored in units of individual frames, is utilized to save original input images and also as a working memory used during the image processing. The vehicle backing assist control program in the embodiment is stored in the program memory 6d. The CPU 6e is a microcomputer that executes the vehicle backing assist processing in the embodiment. The I/O unit 6f is an interface to which various signals from the reverse switch 9, the steering angle sensor 10, the vehicle speed sensor 11 and the setting switch 12 are input. The image switch-over unit 6g outputs an image obtained by effecting a switch-over between the camera image CS and the navigation image NS to the display 7 as the output image VS.

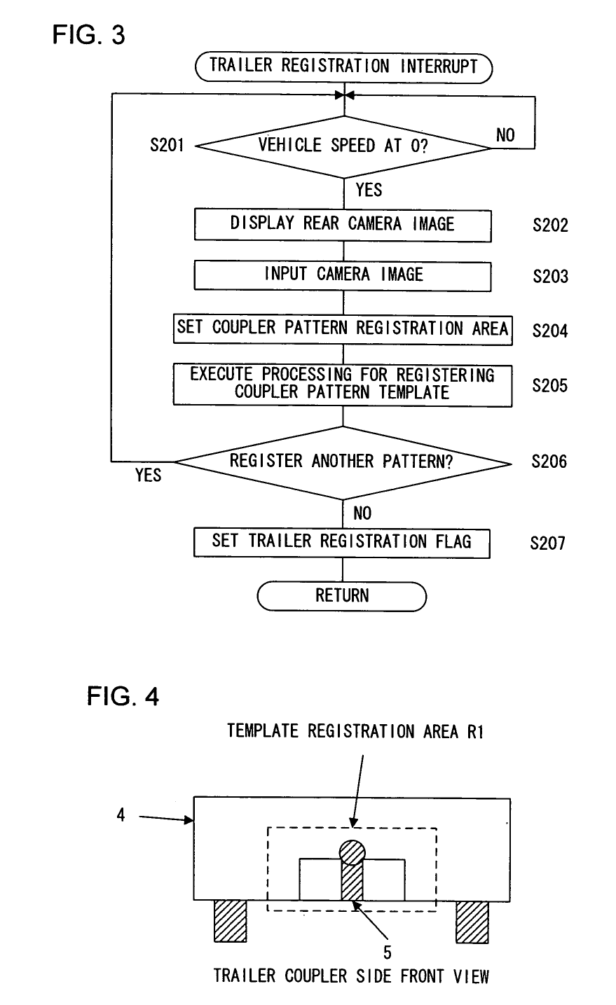

Now, the operation executed to register at the apparatus an image pattern corresponding to the connection target vehicle is explained. FIG. 3 presents a flowchart of the trailer registration interrupt routine. As an image pattern registration operation is performed via the setting switch 12, an interrupt is applied at the CPU 6e and, in response, the CPU 6e executes the interrupt routine in FIG. 3.

In step S201, a verification is executed to determine whether or not the vehicle speed detected at the vehicle speed sensor 11 is equal to or lower than a predetermined value which is set close to 0, i.e., whether or not the vehicle is in a stopped state. Since an image of the trailer cannot be captured for the image pattern registration in undesirable manner while the vehicle is moving, the operation waits in standby if the vehicle is judged to be moving until it is confirmed to have entered a stopped state. Once it is judged to be in a stopped state, the operation proceeds to step S202. In step S202, an image of the area behind the vehicle captured with the camera 2 is displayed at the display 7.

In step S203 following step S202, the camera image CS is digitized and the digital image is input to the image processing control device 6. It is to be noted that before the camera captures the image, the operator stops the vehicle 1 so that the trailer 4 is positioned over a predetermined distance behind the subject vehicle, e.g., over a 5 m distance, to ensure that an image of the side of the trailer 4 on which the trailer hitch 5 is mounted can be captured.

Next, the operator selects a rectangular area Rt (the area enclosed within the dotted line in FIG. 4) which contains the trailer hitch 5 as a hitch pattern registration area by operating the setting switch 12 while monitoring the image of the trailer 4 displayed at the display 7. In step S204 following step S203, the rectangular area Rt having been selected through the setting switch 12 is input and is set as the hitch pattern registration area. In step S205 following step S204, the image over the selected area Rt is stored in the image memory 6c and registered as a template image of the hitch pattern of the trailer 4.

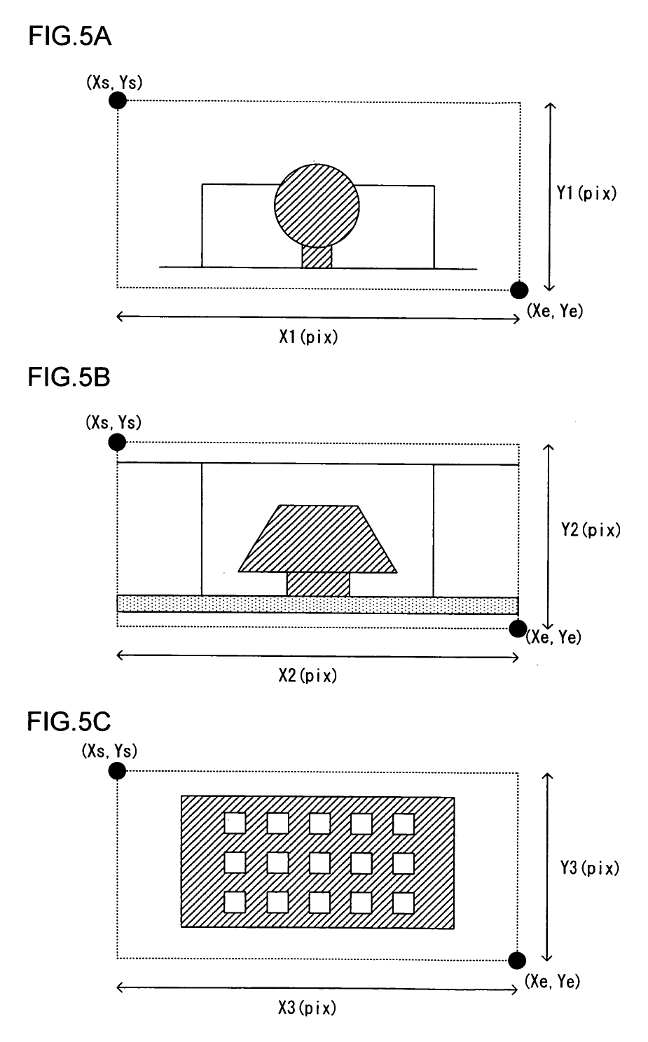

FIG. 5A presents an example of a hitch pattern template image. A template image is a variable-density pattern with a pixel-unit resolution of a rectangular area around the trailer hitch 5 ranging from start point coordinates (Xs, Ys) to end point coordinates (Xe, Ye) on the image. The size of this rectangular area containing X1 pixels along the horizontal direction and Y1 pixels along the vertical direction is determined in correspondence to the image height at which the trailer hitch 5 is projected on the image, i.e., in correspondence to the distance from the camera 2 to the trailer hitch 5. The template image in FIG. 5A, for instance, is an image captured when the distance is 5 m.

FIG. 5B shows an example of a template image of the trailer hitch 5 assuming a different shape. The rectangular area contains X2 pixels along the horizontal direction and Y2 pixels along the vertical direction. While the distance from the camera 2 to the trailer hitch 5 is the same as that in FIG. 5A, the size of the rectangular area Rt on the image is adjusted in conformance to the shapes of the trailer hitch 5 and the surrounding area.

In step S206 in FIG. 3, a verification operation is executed to determine whether or not another hitch pattern is to be registered. If a registration operation has been performed through the setting switch 12, it is judged that another hitch pattern is to be registered and accordingly, the operation returns to step S201 to repeatedly execute the processing described above. If, on the other hand, no registration operation has been executed, it is judged that no hitch pattern is to be registered and the operation proceeds to step S207.

The other hitch pattern registered in this situation may be any of a plurality of patterns obtained by capturing images of the hitch 5 of the same trailer 4 along a diagonal direction instead of a hitch pattern of a trailer hitch at another trailer 4 that may also be connected to the vehicle 1. If the hitch pattern of another trailer is registered, the vehicle can be connected to a different type of trailer, whereas if another pattern of the same trailer hitch captured from a diagonal direction is registered, the presence of the trailer 4 can be confirmed with a higher degree of reliability even when the positional relationship between the vehicle 1 and the trailer 4 prior to the coupling operation is somewhat offset.

If no more hitch patterns are to be registered, a trailer registration flag is set and the trailer registration interrupt is terminated in step S207 before the operation makes a return.

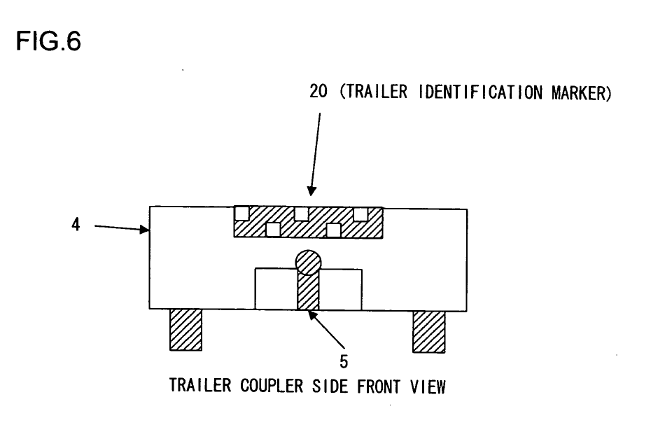

It is to be noted that while a pattern of the trailer hitch 5 is registered in the template image registration described above, an image other than a hitch pattern image may be registered instead. For instance, an identification marker 20 having printed thereon an inherent pattern, as shown in FIG. 6, may be mounted at the trailer 4 and a rectangular area surrounding the identification marker 20 ranging from start point coordinates (Xs, Ys) to end point coordinates (Xe, Ye) and containing X3 pixels along the horizontal direction and Y3 pixels along the vertical direction (see FIG. 5C) may instead be registered as the template area Rt. In such a case, the identification marker 20 should be disposed at a nearby position directly above the trailer hitch 5. Since an extremely conspicuous pattern can be registered as a template image by using the identification marker, the reliability of the decision made with regard to the presence of the trailer 4, which is to be detailed later, is further improved.

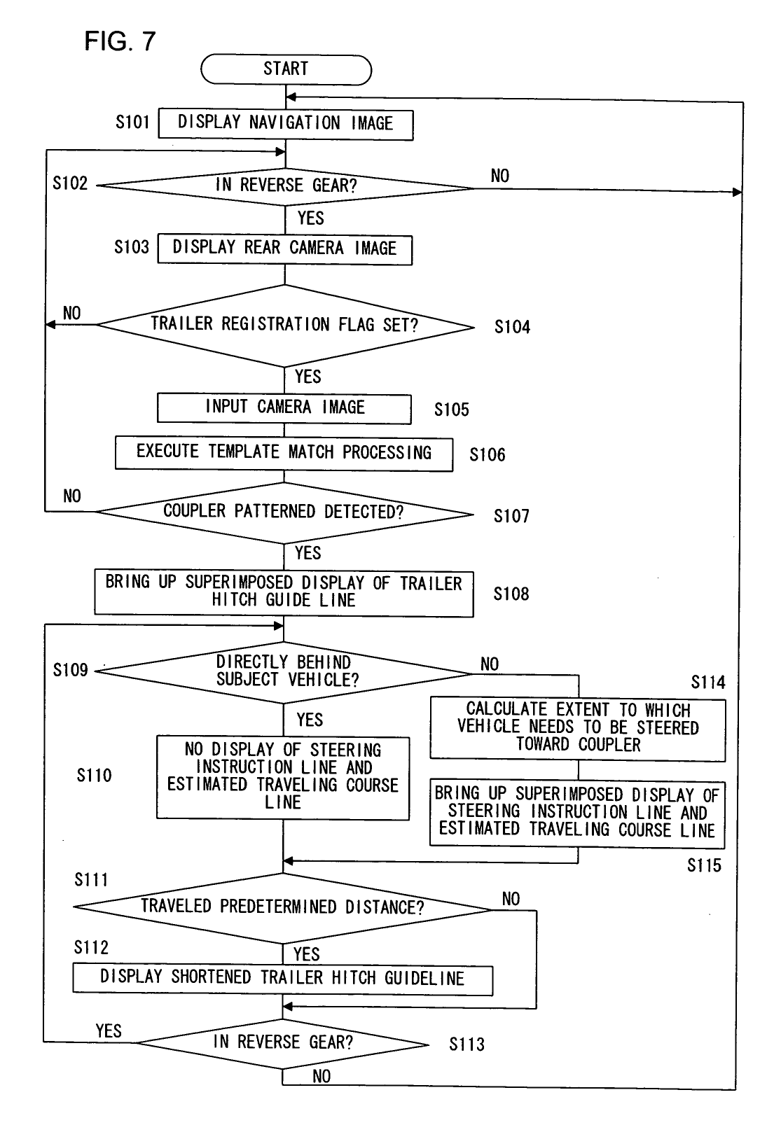

Next, the vehicle backing assist operation executed in the embodiment is explained. FIG. 7 presents a flowchart of the processing executed in conformance to the vehicle backing assist control program used in the embodiment. As the ignition switch (not shown) of the vehicle 1 is turned on, the CPU 6e in the image processing control device 6 starts executing the control program.

In step S101, the image switch-over unit 6g selects the roadmap image NS generated at the navigation device 8 and the selected image is displayed at the display 7. In step S102 following step S101, a decision is made as to whether or not the transmission (not shown) has been set at the reverse gear position based upon a signal input from the reverse switch 9. If it is decided that the transmission is not currently set at the reverse gear position, the operation returns to step S101 assuming that the transmission is set at the drive (D) position or the parking (P) position to continuously display the navigation image NS. If, on the other hand, it is decided that the transmission has been set at the reverse gear position, the operation proceeds to step S103.

In step S103, the image switch-over unit 6g effects a switch-over from the navigation image NS to the camera image CS and the image of the area behind the vehicle is displayed at the display 7. In step S104 following step S103, a decision is made as to whether or not the trailer registration flag has been set, i.e., whether or not the hitch pattern of the trailer 4 is registered as a template image. If it is decided that the trailer registration flag is not set, the operation returns to step S102 to repeat the processing described above. If, on the other hand, it is decided that the trailer registration flag is set, the operation proceeds to step S105.

In step S105, the image input/output unit 6a converts the camera image CS to a digital image and the digital image is stored into the image memory 6c. In step S106 following step S105, template match processing is executed for the camera image CS stored in the image memory 6c to detect a trailer hitch pattern in the camera image CS.

The template match processing is described in detail. As explained above, a template image is constituted with a variable-density pattern formed with the pixels within the rectangular area containing the trailer hitch 5 or the identification marker 20 (see FIGS. 5A-5C). Through the template match processing, the camera image data are searched to detect an area achieving a high correlational value to the template image. For instance, if the template image was captured over a 5 m photographing distance, an area with a substantially equal size and a substantially identical pattern to those of the template image is bound to be present in the camera image to achieve the maximum correlational value in the template match processing when the distance to the trailer 4 is 5 m. In this case, the trailer 4 is judged to be present at a 5 m point.

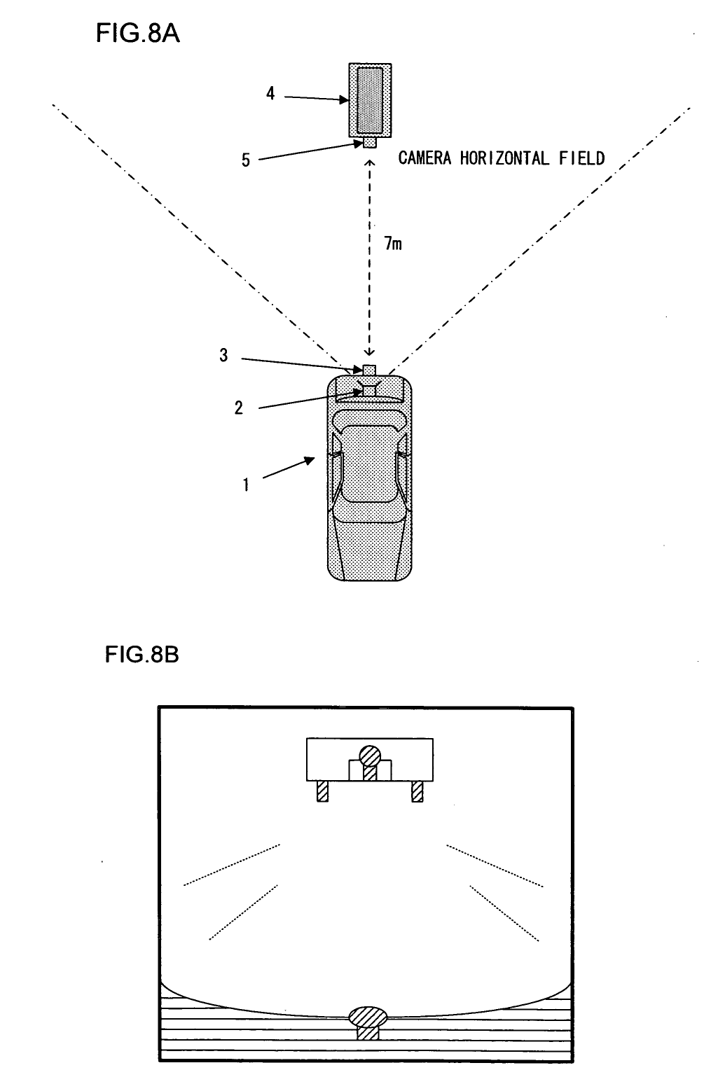

In step S107 following step S106, a decision is made as to whether or not a hitch pattern has been detected through the template match processing. If no hitch pattern has been detected, it is judged either that no trailer 4 is present or that the distance to the trailer 4 is still significant, as illustrated in FIG. 8A, and the operation returns to step S102 to repeatedly execute the processing described above. FIG. 8B shows the camera image CS captured when the distance to the trailer 4 is 7 m.

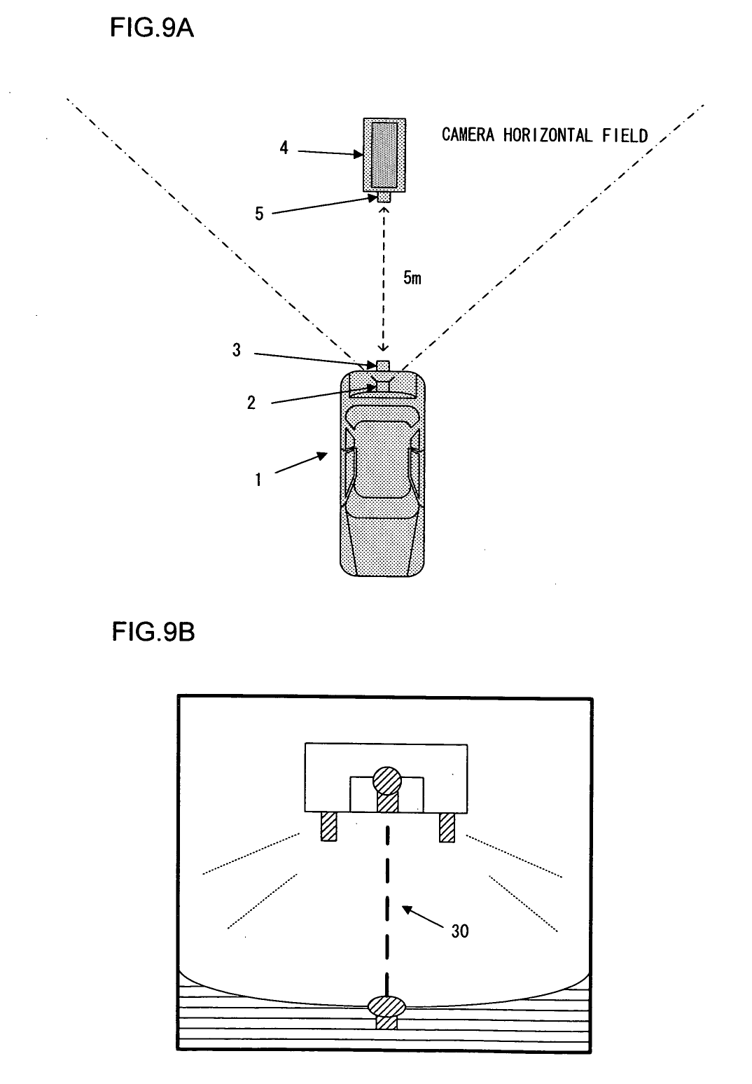

If, on the other hand, a hitch pattern has been detected, a positional relationship such as that shown in FIG. 9A has been achieved between the vehicle 1 and the trailer 4, i.e., a trailer 4 with a registered hitch pattern is present at a 5 m point behind the vehicle 1. If it is decided in step S107 that the hitch pattern has been detected, the operation proceeds to step S108.

In step S108, a trailer connection guide line 30 extending directly behind the hitch 3 installed at the rear of the vehicle 1 over a length equivalent to the distance of 5 m, as shown in FIG. 9B is generated and the trailer connection guide line 30 thus generated is drawn over the camera image CS at the display 7. It is to be noted that coordinates on the road surface can be converted to coordinates on the image plane by using an expression of conversion between the world coordinate system and the camera coordinate system in the known art. Once the guide line 30 is superimposed over the display of the camera image CS, the operation proceeds to step S109.

In step S109, a decision is made as to whether or not the trailer hitch 5 is present directly behind the vehicle 1. This decision can be made by verifying whether or not the trailer hitch 5 or the identification marker 20 provided at a nearby position directly above the trailer hitch 5 is present at the center of the camera image CS. If it is decided that the trailer hitch 5 is present directly behind the vehicle 1, the operation proceeds to step S110.

In step S110, the display of a steering instruction line and an estimated traveling course line which are to be detailed later, is suspended. In step S111 following step S110, a decision is made as to whether or not the traveled distance detected by the vehicle speed sensor 11 has become equal to a predetermined distance. If it is decided that the traveled distance has become equal to the predetermined value, the operation proceeds to step S112, whereas if it is decided that the traveled distance has not become equal to the predetermined value, the operation proceeds to step S113.

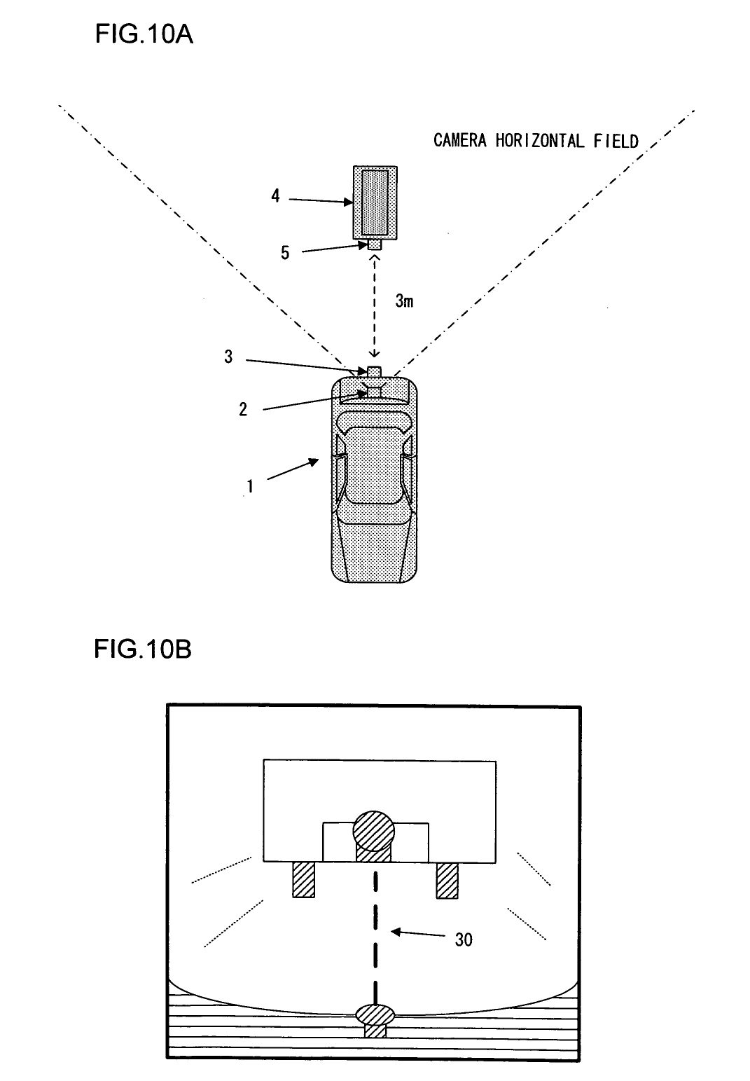

In step S112, a shortened trailer connection guide line 30 is displayed. For instance, let us assume that the vehicle 1 has moved by 2 m from the point at which the trailer 4 was detected and the distance from the vehicle 1 to the trailer 4 has been reduced to 3 m (=5 m−2 m), as shown in FIG. 10A. In this case, the trailer connection guide line 30 is shortened to extend over a length equivalent to the distance of 3 m and the shorter trailer connection guide line is superimposed over the camera image CS, as shown in FIG. 10B. Once the shortened guide line 30 is on display, the operation proceeds to step S113.

In step S113, a decision is made based upon a signal input through the reverse switch 9 as to whether or not the transmission gear is held at the reverse gear position. If it is decided that the transmission gear is held at the reverse gear position, the operation returns to step S109, whereas if it is decided that the transmission gear is not held at the reverse gear position, the operation returns to step S101 and, in either case, the processing described above is repeatedly executed.

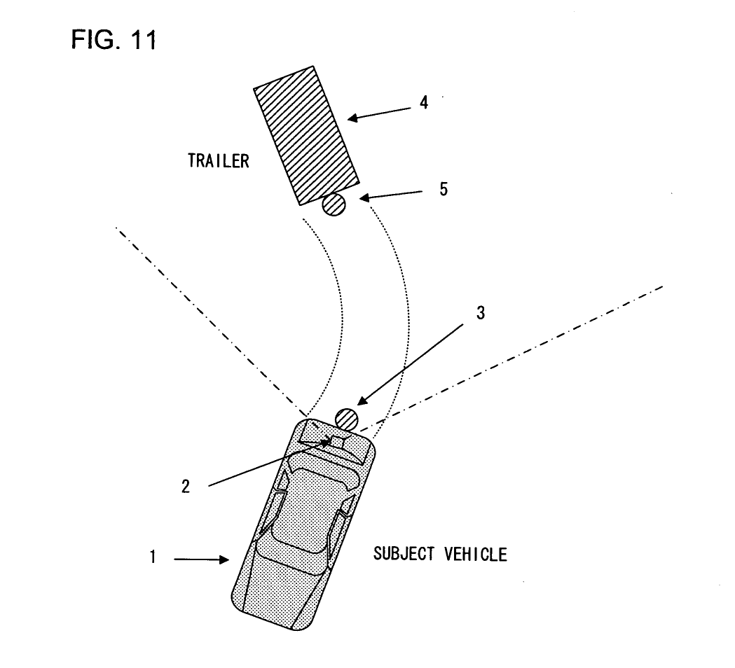

Next, the processing which is executed when a decision is made in step S109 that the trailer hitch 5 is not present directly behind the vehicle 1 is explained. If the positional relationship between the vehicle 1 and the trailer 4 is as illustrated in FIG. 11, for instance, the trailer hitch 5 is not present directly behind the vehicle 1. In this case, the vehicle 1 cannot be connected to the trailer 4 by backing up in a straight line, and the vehicle 1 needs to be backed up while turning.

In step S114, to which the operation proceeds after making a negative decision in step S109, a steering angle θs that needs to be achieved to turn the vehicle 1 along a direction θ toward the trailer hitch 5 relative to the direction extending directly rearward from the vehicle 1 is calculated. It is to be noted that a method that may be adopted to calculate the angle θ formed by the direction extending directly rearward from the vehicle 1 and the direction of the trailer hitch 5 is to be detailed later.

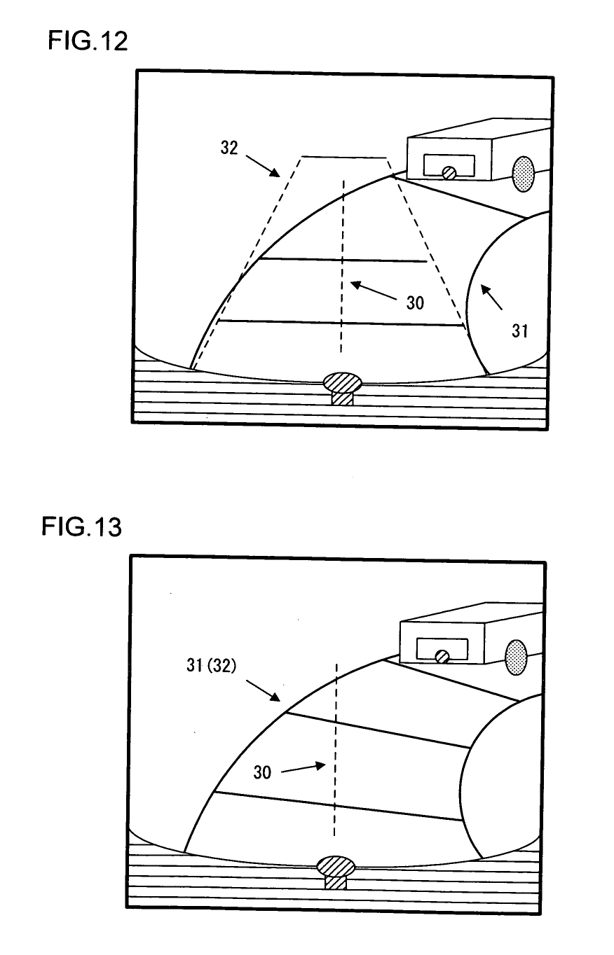

In step S115, a steering instruction line 31 and an estimated traveling course line 32 are generated and these lines are superimposed together with the trailer connection guide line 30 explained earlier over the camera image CS, as shown in FIG. 12. The steering instruction line 31 indicates the locus that will be achieved by the vehicle on the road surface by backing up at the steering angle θs calculated in step S114, and the estimated traveling course line 32 indicates the locus that will be achieved on the road surface by the vehicle by traveling with the current steering angle. After the trailer connection guide line 30, the steering instruction line 31 and the estimated traveling course line 32 are displayed at the display 7, the operation proceeds to step S111.

In step S111, a decision is made as to whether or not the traveled distance detected by the vehicle speed sensor 11 has become equal to the predetermined distance. If it is decided that the traveled distance has become equal to the predetermined value, the operation proceeds to step S112 to display a shortened trailer connection guide line 30 in correspondence to the distance to the trailer hitch 5. At this time, the lengths of the steering instruction line 31 and the estimated traveling course line 32, too, are reduced in correspondence to the distance to the trailer hitch 5.

Now, the method adopted to calculate the angle θ formed by the direction extending directly rearward from the vehicle 1 and the direction of the trailer hitch 5 is explained. When the trailer hitch 5 is detected on the image, coordinates (u, v) of the hitch 5 on the image plane are determined. With Hc representing the mounting height of the camera 2 and φ representing the angle (the angle of depression) formed by the optical axis of the camera 2 and the road surface, the relationship between the world coordinate system (X, Y, Z) and the camera coordinate system (x, y, z) is expressed as follows.
y=Z·sin φ+(Y−Hc)·cos φ (1)
z=Z·cos φ−(Y−Hc)·sin φ (2)
In the expressions presented above, X represents an axis extending along the width of the vehicle, Y represents an axis extending along the height of the vehicle perpendicular to the road surface and Z represents an axis extending along the length of the vehicle. In addition, x represents an axis extending along the horizontal side of the camera 2, y represents an axis extending along the vertical side of the camera 2 and z represents an axis extending along the optical axis of the camera 2.

Furthermore, with f representing the focal length of the camera 2, the relationship between the image plane (image capturing plane) coordinate system (u,v) and the camera coordinate system (x, y, z) is expressed as in (3) and (4) presented below.
u=f·x/z (3)
v=f·y/z (4)
Expressions (2) and (3) indicate that when X=x, the image projected at the horizontal coordinate u on the image plane correspond to a position on the road surface which is distanced along the horizontal direction from the subject vehicle position by
X=u/f·(Zt cos φ−(Yt−Hc) sin φ) (5)
In the expressions presented above, Yt represents the height of the trailer hitch 5 measured from the road surface, and Zt represents the distance to the trailer hitch 5 detected through template matching.

Based upon expressions (1), (2) and (4), the vertical coordinate v on the image plane can be expressed as in (6).
v=f·(Z sin φ+(Yt−Hc) cos φ)/(Zt cos φ−(Yt−Hc) sin φ) (6)
By modifying expression (6), the height Yt of the trailer hitch 5 can be expressed as in (7) below.
Yt=((v/f·Zt+Hc) cos φ+(v/f·Hc−Zt) sin φ)/(cos φ+v/f·sin φ) (7)

Thus, by using expression (7) for substitution in expression (5), the horizontal position X of the trailer hitch 5 can be calculated. Once the horizontal position X is determined, the angle θ formed by the direction running directly rearward from the vehicle 1 and the direction of the trailer hitch 5 can be expressed as in (8) below.
θ=tan⁻¹ (X/Zt) (8)

Since the relationship between the steering angle θs of the vehicle and the turning radius can be univocally calculated based upon the vehicle parameters, the extent to which the vehicle 1 needs to be steered to turn it along the direction θ, too, can be determined. FIG. 13 illustrates a state in which the estimated traveling course line 32 is aligned with the steering instruction line 31 while the steering instruction line 31 is up on display. The operator (driver) can position the vehicle as close as possible to the trailer hitch 5 by operating the steering wheel so as to align the estimated traveling course line 32 to the steering instruction line 31.

The processing executed by the vehicle backing assist apparatus in the embodiment is summarized below. A template image of the hitch 5 of the connection target trailer 4 to the subject vehicle or the identification marker 20 provided at a nearby position directly above the hitch 5, which is captured by the camera 2, is stored in advance and a decision is made as to whether or not an image behind the subject vehicle captured by the camera 2 includes an image portion matching the template image. If it is decided that the image includes a portion matching the template image, the trailer connection guide line 30 extending directly rearward from the hitch 5 at the subject vehicle 1 is superimposed over the display of the image behind the subject vehicle. Thus, the guide line 30 is superimposed over the display only if the connection target trailer 4 is present behind the subject vehicle 1. Namely, since no guide line 30 is displayed if the connection target trailer 4 is not present, the driver does not become distracted by an unnecessary line on the display.

In addition, the vehicle backing assist apparatus in the embodiment displays a shortened trailer connection guide line 30 in correspondence to the distance traveled by the subject vehicle after the presence of an image portion matching the template image is verified, and thus, the operator is not distracted by a display of an unnecessarily long guide line 30.

Furthermore, the vehicle backing assist apparatus in the embodiment calculates the direction θ of the hitch 5 at the connection target trailer 4 or the identification marker 20 provided at a nearby position directly above the hitch 5 relative to the direction extending directly rearward from the subject vehicle 1, generates the steering instruction line 31 based upon the direction θ thus calculated and displays the steering instruction line 31 on the image behind the subject vehicle. As a result, even when the trailer hitch 5 is not present directly behind the subject vehicle 1, the operator can easily ascertain the extent to which the subject vehicle 1 needs to be steered toward the trailer hitch 5 and ultimately, the subject vehicle 1 can be accurately and easily connected to the trailer 4.

The present invention is not limited to the embodiment described above. For instance, the trailer connection guide line 30, the steering instruction line 31 and the estimated traveling course line 32 may be displayed in red or with a dotted line, a chain line or a bold line for emphasis to improve its visibility.

While the height of the trailer hitch 5 is calculated based upon the coordinates on the image plane in the explanation provided above, the height of the trailer hitch 5 may be directly entered through the setting switch 12 during the template registration. In such a case, the processing executed to calculate the height of the trailer hitch 5 can be omitted.

Moreover, while an explanation has been given above on an example in which the instructions are provided to guide the vehicle toward the trailer 4 by displaying the guideline, the extent to which the vehicle needs to be steered may be indicated through, for instance, an audio message, instead. In such a case, too, the subject vehicle 1 can be accurately and easily connected to the trailer 4.

The disclosure of the following priority application is herein incorporated by reference:
Japanese Patent Application No. 2003-344708 filed Oct. 2, 2003

1. A vehicle backing assist apparatus comprising:
an image capturing device that captures an image of a view behind a subject vehicle;
a judging device that judges as to whether or not a connection target vehicle to be connected with the subject vehicle is present behind the subject vehicle based upon the image captured by the image capturing device;
a drawing device that draws a guide line extending rearward from a coupler at the subject vehicle over the image of the view behind the subject vehicle captured by the image capturing device when the judging device judges that the connection target vehicle to be connected with the subject vehicle is present; and
a display device that displays an image of the view behind the subject vehicle with the guide line superimposed thereupon.

2. A vehicle backing assist apparatus according to claim 1, further comprising:
a storage device that stores in memory at least one of an image of a coupler at the connection target vehicle and an image of an identification marker provided near the coupler captured in advance by the image capturing device as a template image, wherein:
if the image captured by the image capturing device includes a portion matching the template image stored in the storage device, the judging device judges that the connection target vehicle to be connected with the subject vehicle is present behind the subject vehicle.

3. The vehicle backing assist apparatus according to claim 1, further comprising:
a distance detection device that detects a traveled distance traveled by the subject vehicle, wherein:
the drawing device reduces the length of the guide line based upon the traveled distance detected by the distance detection device after the judging device judges that the connection target vehicle to be connected with the subject vehicle is present.

4. A vehicle backing assist apparatus according to claim 1, further comprising:
a direction calculation device that calculates a direction of one of the coupler at the connection target vehicle and the identification marker provided near the coupler relative to a direction running directly rearward from the subject vehicle wherein:
the drawing device generates a steering instruction line to be used to set the coupler at the subject vehicle closer to the coupler at the connection target vehicle based upon the direction calculated by the direction calculation device and draws a steering instruction line over the image behind the subject vehicle captured by the image capturing device.

5. A vehicle backing assist apparatus according to claim 4, further comprising:
a steering guidance device that provides audio steering guidance to guide the coupler at the subject vehicle closer to the coupler at the connection target vehicle based upon the direction calculated by the direction calculation device.

6. A vehicle backing assist apparatus according to claim 1, wherein:
the display device highlights the guide line.

7. A vehicle backing assist apparatus according to claim 1, wherein:
the drawing device draws the guide line by using a dotted line, a chain line or a bold line.

8. A vehicle backing assist apparatus comprising:
an image capture means for capturing an image of a view behind a subject vehicle;
a judgment means for judging as to whether or not a connection target vehicle to be connected with the subject vehicle is present behind the subject vehicle based upon the image captured by the image capture means;
a drawing means for drawing a guide line extending rearward from a coupler at the subject vehicle over the image of the view behind the subject vehicle captured by the image capture means when the judgment means judges that the connection target vehicle to be connected with the subject vehicle is present; and
a display means for displaying an image of the view behind the subject vehicle with the guide line superimposed thereupon.

9. A vehicle backing assist method, comprising;
capturing an image of a view behind a subject vehicle;
judging as to whether or not a connection target vehicle to be connected with the subject vehicle is present behind the subject vehicle based upon the captured image;
drawing a guide line extending rearward from a coupler at the subject vehicle over the image of the view behind the subject vehicle if the connection target vehicle to be connected with the subject vehicle is determined to be present; and
displaying the image of the view behind the subject vehicle with the guide line superimposed thereupon.
